(19) United States
(12) Patent Application Publication
(10) Pub. No.: US 2015/0248352 A1
(43) Pub. Date: Sep. 3, 2015

(54) METHODS AND SYSTEMS FOR OPTIMIZATION OF STORAGE PERFORMANCE ACROSS MULTIPLE COMPUTE DEVICES

(71) Applicant: Dell Products, L.P., Round Rock, TX (US)

(72) Inventors: Carlton A. Andrews, Austin, TX (US); Gary Douglas Huber, Austin, TX (US); Todd Swierk, Austin, TX (US); William F. Sauber, Georgetown, TX (US); Philip M. Seibert, Austin, TX (US)

(73) Assignee: Dell Products, L.P., Round Rock, TX (US)

(21) Appl. No.: 14/194,648

(22) Filed: Feb. 28, 2014

(51) Int. Cl. G06F 12/08

(52) U.S. Cl. CPC G06F 12/0875; G06F 2212/452

(57) ABSTRACT

Embodiments of methods and systems for optimization of centralized storage performance across multiple compute devices are presented. In an embodiment a method may include storing user data in a data storage location that is remote to a user interface device. The method may also include determining a subset of the user data for local storage in response to a data storage policy and at least one usage attribute. Additionally, the method may include storing the sub-set of the user data in a data cache that is local to the user interface device.

### FIELD

This disclosure relates generally to computer systems, and more specifically, to methods and systems for optimization of storage performance across multiple compute devices.

### BACKGROUND

Computer users often interface with a variety of different computing device platforms in a given period of time. For example, in a single day a person may access user data on personal computing devices such as a laptop, tablet, smartphone, or desktop computer. In such an example, the person may access user data on a tablet device at home, before leaving for work. During the commute to and from work on a train or bus, for example, the person may access user data such as media files, videos, or books with a smartphone device. At work, the person may access user data stored in file systems, work-related applications, and work-related data files. At lunch, the person may make one or more telephone calls using personal and work-related contacts. The person may also access a calendar or email to prepare for the afternoon's meetings or other work events. Upon returning home, the person may access picture files, prepare personal documents, and create other data sets of personal information. Some people may continue to work at home by accessing work-files remotely. In such an example, the person may access several different data sets on several different device platforms in a given day.

Challenges arise, because the data sets are typically stored in local data storage devices that is directly attached on the compute device. As used herein, the term “data set” means a combination of data files or folders having similar key attributes, such as work documents or vacation pictures. Thus, as the person switches from one device to another, data needed to continue productivity may not be readily available. Many systems require data transfer using an intermediary storage device, such as an external USB flash memory device or a data storage disk. The problem with that arrangement is that the portable storage devices may be lost or damaged. Additionally, it takes additional time for the user to ensure that the data is stored to the portable storage device prior to swapping devices. It then takes additional time and resources to access the data on the new platform. These issues create opportunities loss of data and a reduction of overall productivity.

There exist some remote storage systems, such as cloud storage systems, for storing data remotely. It may be possible to access data stored on a cloud storage from multiple user interface devices. For example, a user may store certain files directly to a folder on a cloud drive from a desktop computer, and then access the same file from a tablet device. One problem with these devices is that there may be access limitations due to network latency. Another problem is that the service is only available from one specific cloud provider which does not allow the user to span across multiple cloud services. Additionally, datasets are distributed across all devices without any intelligence of placement of the data.

Some corporations use group centralized data storage systems for consolidating important data on file systems. For example, a person may work on a document at work and then save the document to a networked drive on the group centralized data storage system. The person may then access the same file later, either at a different workstation within the corporate location, or through a Virtual Private Network (VPN) from home. Network latency and system resources may cause losses of productivity, particularly when the files are accessed remotely.

### SUMMARY

Embodiments of methods and systems for optimization of centralized, remote, and distributed storage performance across multiple compute devices are presented. In an embodiment, the method may provide a data management solution that determines a data storage location in response to data attributes, compute device attributes, and user behavior. In an embodiment a method may include storing user data in a data storage location that is remote to a user interface device. The method may also include storing a sub-set of the user data in a data cache that is local to the user interface device. Additionally, the method may include determining whether a requested sub-set of user data is stored in the data cache. The method may also include obtaining the requested sub-set of user data from the data cache in response to a determination that the requested sub-set user data is stored in the data cache and obtaining the requested sub-set of user data from the data storage location in response to a determination that the requested sub-set of user data is not stored in the data cache.

In one embodiment, the user data comprises a data file. In another embodiment, the user data comprises an application file.

The method may include storing the requested sub-set of user data in the data cache in response to the requested sub-set of user data being obtained from the data storage location. Additionally, the method may include storing the requested sub-set of user data in the data cache in response to a determination that a data caching policy specifies retention of the requested sub-set of user data.

The method may also include maintaining a data cache of user data on each of a plurality of user interface devices, each user interface device being configured to access user data stored in the data storage location, each data cache comprising a device-specific sub-set of user data. The method may further include synchronizing updates to user data cached in the data cache of a first user interface device with corresponding user data in the storage location and with corresponding user data stored in a data cache of a second user interface device. Additionally, the method may include flagging a sub-set of the user data stored on the data storage location in response to a determination that a corresponding sub-set of the user data has been stored in the data cache.

An Information Handling System (IHS) configured for optimization of centralized storage performance across multiple compute devices is also presented. In an embodiment, the IHS includes a processor and a memory coupled to the processor, the memory including program instructions stored thereon that, upon execution by the processor, cause the IHS to perform special operations. In an embodiment, the operations include storing user data in a data storage location that is remote to the IHS; storing a sub-set of the user data in a data cache that is local to the IHS, and determining whether a requested sub-set of user data is stored in the data cache, obtaining the requested sub-set of user data from the data cache in response to a determination that the requested sub-set user data is stored in the data cache, and obtaining the requested sub-set of user data from the data storage location in response to a determination that the requested sub-set of user data is not stored in the data cache.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating one embodiment of a system for optimization of storage performance across multiple compute devices.

FIG. 2 is a diagram illustrating one embodiment of a system for optimization of storage performance across multiple compute devices.

FIG. 3 is a block diagram of an example of an Information Handling System (IHS) according to some embodiments.

FIG. 4 is a flowchart diagram illustrating one embodiment of a method for optimization of storage performance across multiple compute devices.

FIG. 5 is a system flow diagram illustrating one embodiment of a method for optimization of storage performance across multiple compute devices.

FIG. 6 is an illustration of one embodiment of attributes for optimization of storage performance across multiple compute devices.

FIG. 7 is a flowchart diagram illustrating one embodiment of a method for optimization of storage performance across multiple compute devices.

### DETAILED DESCRIPTION

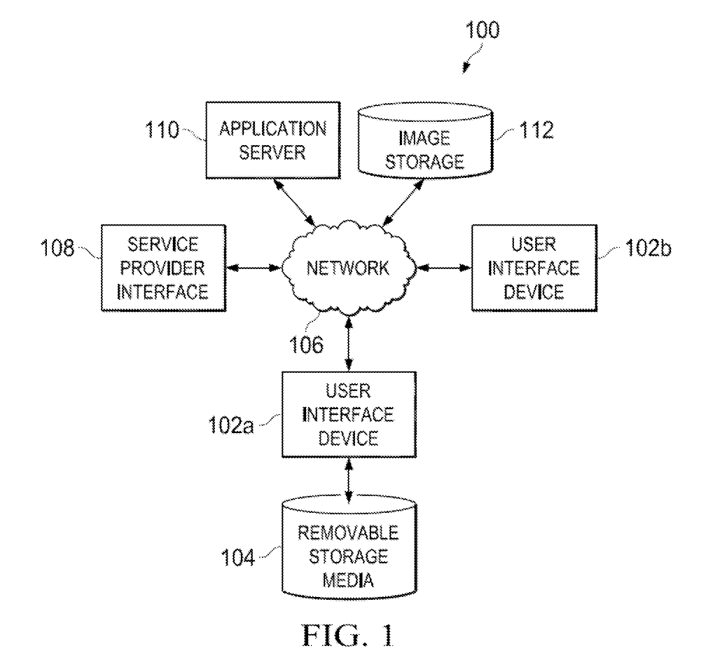

FIG. 1 is a diagram illustrating one embodiment of a system 100 for optimization of centralized storage performance across multiple compute devices. In an embodiment, the system 100 includes one or more user interface devices 102a-b. The user interface devices 102a-b may be computing devices, such as desktop computers, laptop computers, tablet computing devices, mobile computing devices, etc. In other embodiments, the user interface devices may include or be coupled to servers, networking devices, security appliances, or the like. In still other embodiments, the user interfaces may be of diverse types. For example, a first user interface device 102a may be a desktop workstation, and a second user interface device 102b may be a mobile computing device or a tablet computing device. In certain embodiments, aspects of the first user interface device 102a may be tied or related to aspects of the second user interface device 102b. For example, a selection of a user's files, accounts, configuration, applications, etc. may be shared between the first user interface device 102a and the second user interface device 102b. One of ordinary skill will recognize a variety of user interface devices 102a-b that may be configured according to the present embodiments.

In an embodiment, the system 100 may include a removable storage medium 104 which may store information used by the user interface device 102a. Examples of removable storage media 104 include flash memory drives, Secure Digital (SD) cards, optical storage disks, external magnetic disk drives, external Solid State Drives (SSD), etc. In an embodiment, the removable storage media 104 may communicate with the user interface device 102a through a data communication port, such as a Universal Serial Bus (USB) port, or the like. Alternatively, the removable storage media 104 may communicate with the user interface device 102a wirelessly through, e.g., a WiFi or Bluetooth communication interface.

User interface devices 102a-b may be configured to communicate via an interface to network 106. Network 106 may include a Local Area Network (LAN), a Wide Area Network (WAN) connection, a connection to the Internet, etc. The network 106 may include various components, such as network routing devices, network switching devices, network hubs, network firewalls, wireless access points, mobile data connections, telecommunications network backbone hardware, etc. In various embodiments, the network 106 may be configured to receive communication requests from the user interface devices 102a-b and transmit responses from other devices connected to the network 106 back to the user interface devices 102a-b.

In an embodiment, the system 100 may include one or more devices or subsystems which may be provided to service the user interface devices 102a-b. For example, service provider interface 108 may be provided to allow a service provider to communicate with the user interface device 102a. In one example, embodiment, the service provider may be a technical support technician. The technical support technician may establish a user support session, such as a chat session with a user of the user interface device 102a, b. The user support session may additionally include a remote access session, a file transfer session, a voice or video connection, etc. In an embodiment, the user support session may be requested by the user of the user interface device 102a, b. In another embodiment, the user interface device 102a, b may automatically request the user support session in response to encountering a system error.

In an embodiment, the system 100 may also include an application server 110. In such an embodiment, the application server 110 may provide the user interface devices 102a-b with access to one or more applications 110. For example, the user interface device 102a-b may operate as a thin client which displays video related to operations of an application hosted by application server 110, but does not directly handle processing of data associated with operation of the application. In a further embodiment, the user interface device 102a-b may additionally provide an interactive interface allowing the user to enter data or manipulate operation of the application. Data and commands entered by the user at the user interface device 102a, b may be communicated to application server 110 via network 106.

In one example, the application server 110 may be accessed by the user interface device 102a, b in the event of a failure being detected at the user interface device 102a. For example, in the event of a system failure of an operating system, the user interface device 102a, b may automatically switch to a fault recovery mode. In the fault recovery mode, the user interface 102a may still be used by the user to perform tasks, but the operating system may be operated on the application server 110 and the user interface device 102a may simply operate as a user interface client of the application server 110 allowing the user to enter inputs which are communicated to the application server 110 via network 106, and seeing responsive actions of the operating system on the application server 110. One of ordinary skill will recognize additional examples involving applications which may be hosted by application server 110, including word processing applications, email applications, photo editing applications, etc.

In an embodiment, image storage 112 may provide remote storage functionality for user interface device 102a. In one embodiment, the image storage 112 may store a complete image of the data stored on user interface device 102a, b. In another embodiment, the image storage 112 may store a partial image of data stored on the user interface device 102a, b. For example, a selection of files or folders stored on the user interface device 102a may be designated for storage on the image storage 112. In such an embodiment, the files or folders may be communicated to image storage 112 via network 106 for storage. In still another embodiment, incremental changes to information stored on the user interface device 102a may be communicated to image storage device 112, such that the copies of information stored on image storage 112 are synchronized with the information stored on user interface device 102a.

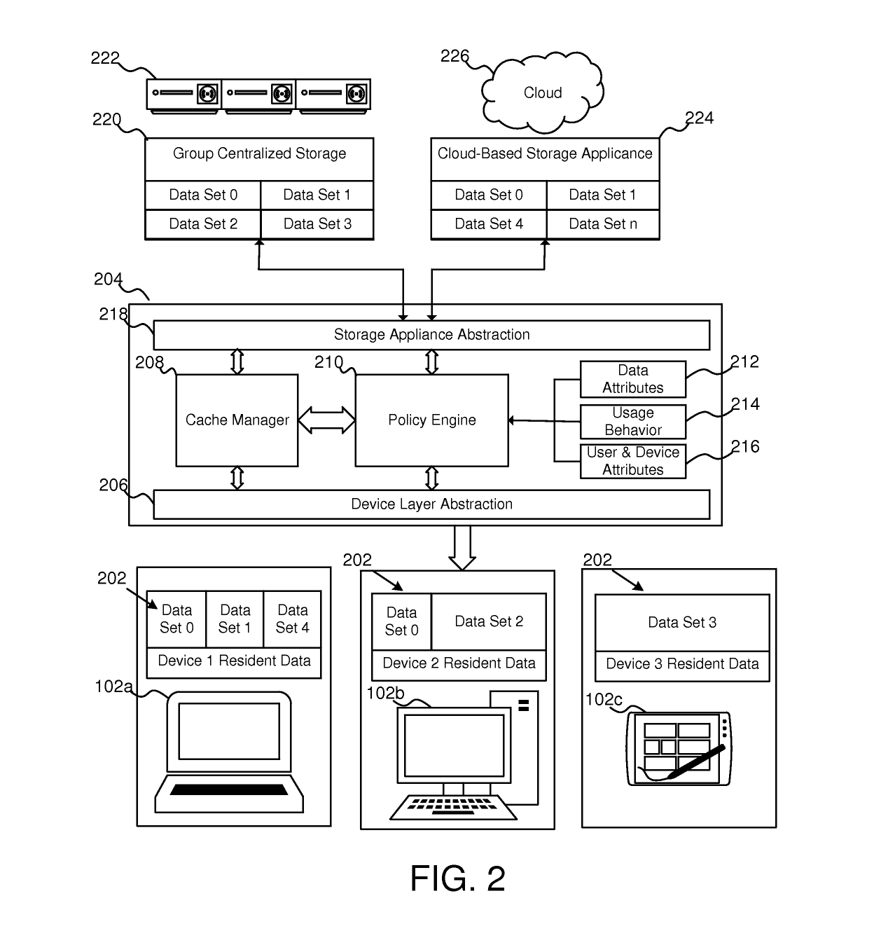

The system 100 of FIG. 1 is just one example of a possible system which may be used according to the present embodiments. Certain components of system 100 may be added or omitted without substantial change to the fundamental operation of the system. For example, while it may be useful to include a removable storage media 104, this component of system 100 may be omitted in various embodiments. Similarly, a user interface device 102 may access an application server during a user support session, but this component of system 100 may also be omitted in various embodiments. Additionally, image storage 112 may be useful to a service technician during a user support session, but this component may also be omitted in various embodiments. One of ordinary skill will also recognize that certain components may be added to system 100, for example as shown in FIG. 2.

FIG. 2 illustrates a further embodiment of a system 200 for optimization of centralized storage performance across multiple compute devices. In such an embodiment, the system 200 may include multiple user interface devices 102a-c. In the illustrated example, user interface 102a is a laptop computer, user interface 102b is a desktop computer, and user interface 102c is a tablet computer. One of ordinary skill will recognize alternative embodiments of user interface devices 102, such as smartphones, Personal Data Assistants (PDAs), e-readers, etc. In the depicted embodiment, each user interface hosts one or more datasets 202, which have been labeled as data sets 0-4 for illustrative purposes. For example, user interface 102a may host resident data comprising data set 0, data set 1, and data set 4. Similarly, user interface 102b may host data set 0 and data set 2. User interface device 102c may host data set 3.

A user may store data sets from each of the user interface devices 102a-c to a remote data storage device, such as cloud 226 or group centralized storage 220. In an embodiment, the group centralized storage 220 may include one or more data storage devices 222, such as data storage disks. In a particular embodiment, the data storage devices 222 may be configured in an array. In a further embodiment, the data storage devices 222 may be configured in a redundant configuration for data protection. In such an embodiment, the user may store all of data sets 0-4 on cloud 226, but store copies or partial copies of certain data sets locally in cache 202 on each user interface device 102a-c. For example, data set 3 may include media files which the user commonly accesses on the tablet user interface device 102c. In such an embodiment, the tablet user interface device 102c may store a copy of data set 3 locally as a data cache 202. If the user modifies data set 3 in any way, then the cache 202 may be synchronized with the copy stored on the cloud 226. In such an embodiment, the user may be able to access the media files in data set 3 more efficiently than if the files were accessed directly from the cloud 226. Similarly, user interfaces 102a-b may also store certain data sets as a local cache 202 as shown in FIG. 2.

The system may further comprise a data management layer 204 configured to manage storage of the data sets on the group centralized storage 220 or on the cloud 226. The data management layer 204 may also manage storage and synchronization of data sets stored on the user interface devices 102a-c. In one embodiment, the data management layer 204 may include a device abstraction layer 206 interfacing with the user interface devices 102a-c and a storage appliance abstraction layer 218 interfacing with the group centralized storage 220 and the cloud based storage appliance 224. In an embodiment, the data management layer 204 may include a cache manager 208 and a policy engine 210. The policy engine may reference a data storage policy and one or more policy-related attributes. In an embodiment, the attributes may include data attributes 212, usage behavior 214, and user and device attributes 216 associated with the data sets 0-4. The policy engine 210 may reference a predetermined data storage policy, which may be initialized either by the storage provider or by the user. The policy engine 210 may provide instructions according to the policy to the cache manager 208. In response to the instructions, the cache manager 208 may determine which data sets should be cached on each user interface device 102a-c. The data management layer 204 also determines where the data is located when requested by user devices 202, thus relieving the device or user of maintaining specific knowledge of the existence of multiple storage devices and their architecture. In various embodiments, the devices may include home storage systems as well as corporate databases and cloud storage.

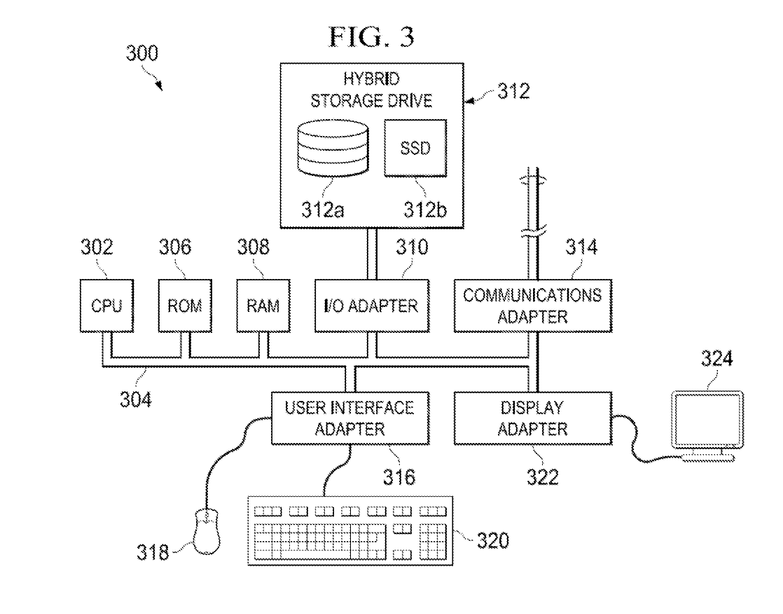

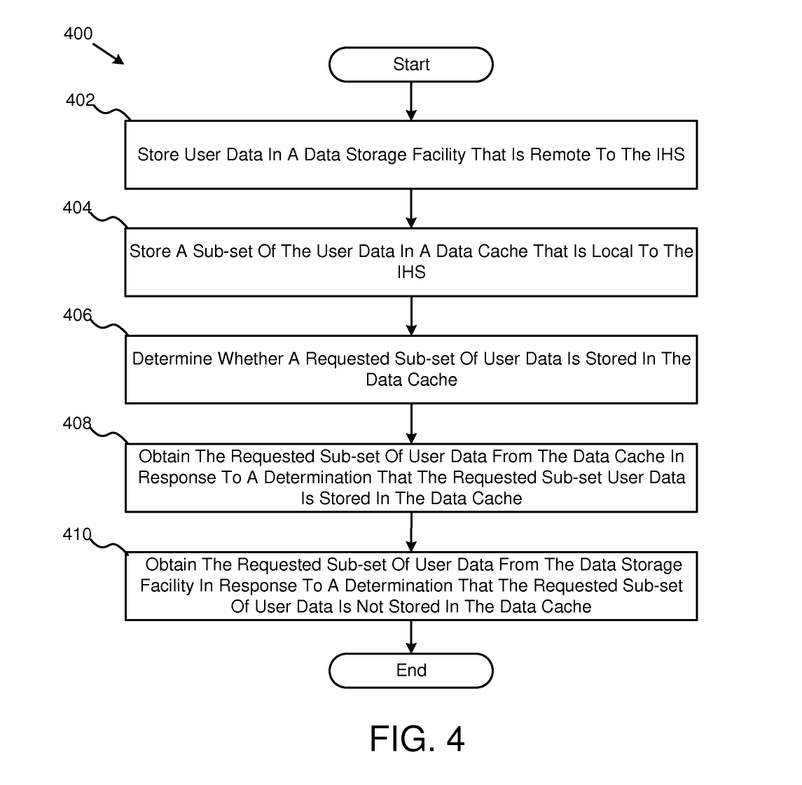

FIG. 3 illustrates a computer system 300 adapted according to certain embodiments of a user interface device 102a-b, the service provider interface 108, the application server 110, and/or the image server 112 and data management layer 204. The central processing unit (CPU) 302 is coupled to the system bus 304. In an embodiment, the processing device may be implemented with CPU 302. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIGS. 4-7.

The computer system 300 also may include Random Access Memory (RAM) 308, which may be SRAM, DRAM, SDRAM, or the like. The computer system 300 may utilize RAM 308 to store the various data structures used by a software application configured to maintain technical support continuity across system restarts and multiple operating systems. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data. In various embodiments, memory 202 of user interface device 102 may be implemented with ROM 306 and/or RAM 308.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information for interacting with operating system 212. In a further embodiment, the display adapter 322 may display a user support session, such as a chat window.

The I/O adapter 310 may connect to one or more storage devices 312, such as one or more of a hard drive, a Compact Disk (CD) drive, a floppy disk drive, a tape drive, to the computer system 300. In a particular embodiment, the storage devices 312 may be hybrid storage drives, which include both magnetic data storage disks 312a and a SSD 312b. In other embodiments, flash memory may be substituted for the SSD 312b. The SSD 312b may comprise the persistent data storage 208, which in one embodiment, may store code for the alternate operating system 212. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, tablet computers, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

FIG. 4 illustrates one embodiment of a method 400 for optimization of centralized storage performance across multiple compute devices. In an embodiment, the method 400 starts at block 402, where the user interface device 102a-c stores user data in a data storage location that is remote to the user interface device 102a-c. The data management layer 204 may then store a data set in a data cache 202 that is local to the user interface device 102a-c as shown at block 404. In an embodiment, the user interface device 102a-c may then determine whether a requested data set is stored in the data cache 202 as shown at block 406. If so, then the user interface device 102a-c obtains the data set from the cache 202 as shown at block 408. If not, then the user interface device 102a-c obtains the data set from the remote storage location as shown at block 410.

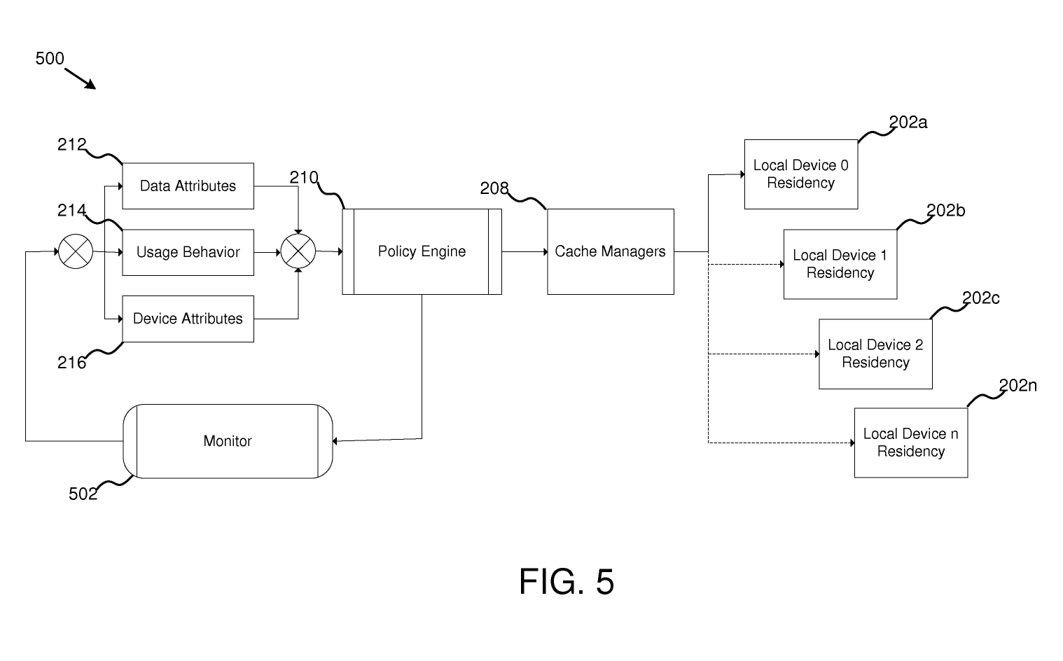

FIG. 5 is a system flow diagram illustrating one embodiment of a method 500 for optimization of centralized storage performance across multiple compute devices. FIG. 5 shows an embodiment of the operation of the data management layer 204. In an embodiment, the data management layer 204 includes a policy engine 210 and a cache manager 208. The data management layer 204 may also include a monitor unit 502 configured to monitor data usage patterns and identify the one or more data usage attributes, including data attributes 212, usage behavior 214, and device attributes 216. The policy engine 210 may reference a predetermined policy and the combination of data attributes to determine caching instructions for the cache manager 208. The cache manager 208 may then determine which data sets to be stored in the local cache 202a-n of each of the user interface devices 102a-c.

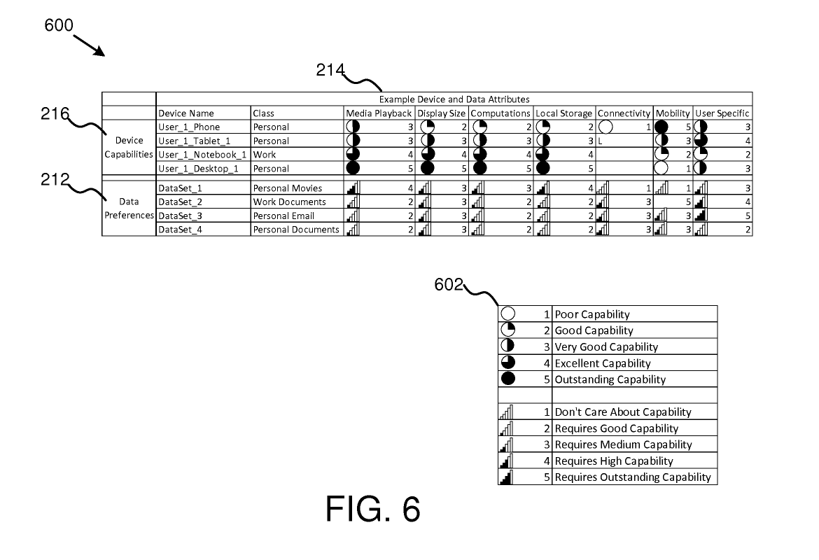

For example, FIG. 6 is an illustration of one embodiment of attributes 600 for optimization of centralized storage performance across multiple compute devices. In the depicted embodiment, the attributes 600 include device attributes 216, such as the device name and the device class. Examples of device classes are shown in FIG. 6 and may include “personal,” “work,” “home,” or “mobile.” The attributes 600 may also include data attributes, such as a data set identifier, and a data description. Examples of data descriptions may include “personal movies,” “work documents,” “personal email,” “work document,” etc. Additionally, the attributes 600 may include usage behavior 214 such as preferences. Examples of preferences include system capability requirements for each data description. Also, in a further embodiment, the attributes 600 may also include indicators or scores of the devices capabilities for various additional attributes or sub-sets of attributes, such as the devices capability to handle certain operations with the data including playback, display, computations, local storage, connectivity, mobility, etc. The attributes 600 may also include indicators or scores of the user's preferences or habits with respect to certain access of certain data sets on certain devices. A legend of these capabilities and preferences is shown in block 602.

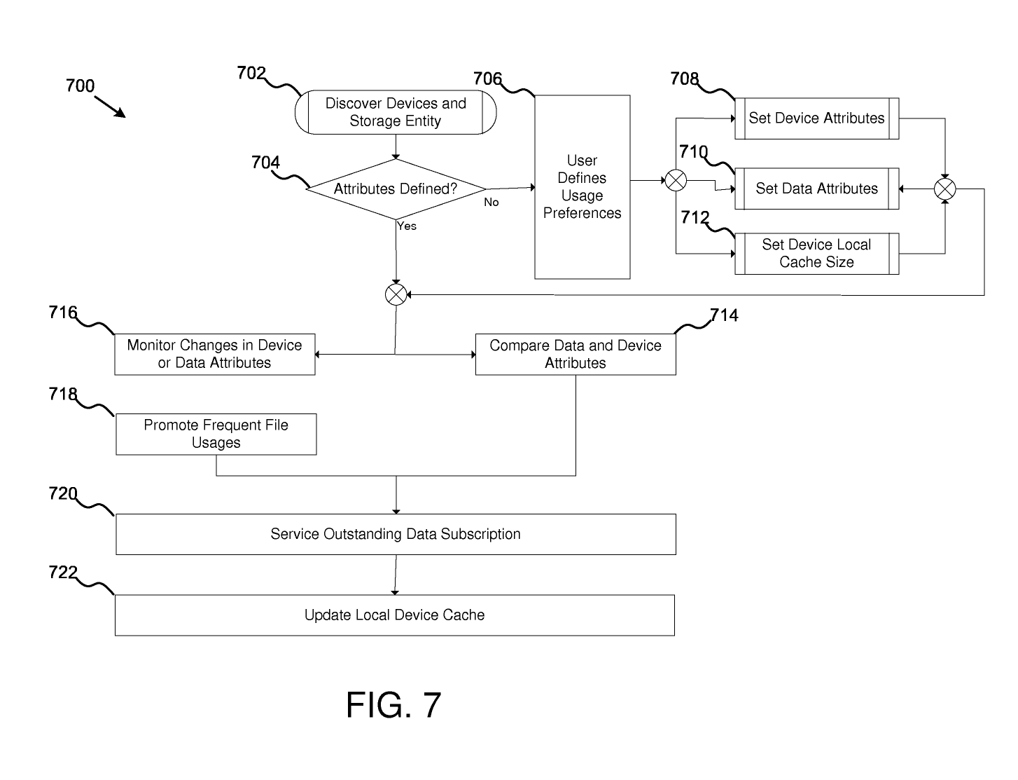

FIG. 7 is a flowchart diagram illustrating one embodiment of a method 700 for optimization of centralized storage performance across multiple compute devices. The diagram in FIG. 7 illustrates operation of the user interface devices 102a-c. In an embodiment, the user interface device 102a-c discovers storage facilities 220, 224 available for remote data storage as shown at block 702. Once the remote storage facilities 220, 224 are discovered, the user interface device 102a-c determines whether storage attributes have been defined for each available storage location 220, 224 as shown at block 704. The user may then define usage preferences as shown at block 706. The user may further set device attributes, data attributes and local cache sizes as shown at blocks 708-712.

The user interface device 102a-c may then monitor for changes in data sets on the device or changes to the device attributes as shown at block 716. The user interface device may also promote frequently used files as shown at block 718. The user interface device 102a-c may also compare the data and device attributes as shown at block 714. Using this information, the user interface device 102a-c may service outstanding data subscription, such as fulfilling user data requests as shown at block 720. Additionally the user interface device 102a-c may update the local device cache, which may include copying files locally based on attributes as shown at block 722.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
storing user data in a data storage location that is remote to a user interface device;
determining a subset of the user data for local storage in response to a data storage policy and at least one usage attribute; and
storing the sub-set of the user data in a data cache that is local to the user interface device.

2. The method of claim 1, further comprising:
determining whether a requested sub-set of user data is stored in the data cache; and
obtaining the requested sub-set of user data from the data cache in response to a determination that the requested sub-set user data is stored in the data cache and obtaining the requested sub-set of user data from the data storage location in response to a determination that the requested sub-set of user data is not stored in the data cache.

3. The method of claim 1, wherein the usage attribute comprises a device-specific attribute.

4. The method of claim 1, wherein the usage attribute comprises a data-specific attribute.

5. The method of claim 1, wherein the usage attribute comprises a user-specific attribute.

6. The method of claim 1, further comprising storing the requested sub-set of user data in the data cache in response to the requested sub-set of user data being obtained from the data storage location.

7. The method of claim 1, further comprising maintaining a data cache of user data on each of a plurality of user interface devices, each user interface device being configured to access user data stored in the data storage location, each data cache comprising a device-specific sub-set of user data.

8. The method of claim 7, further comprising synching updates to user data cached in the data cache of a first user interface device with corresponding user data in the storage location and with corresponding user data stored in a data cache of a second user interface device.

9. The method of claim 1, further comprising flagging a sub-set of the user data stored on the data storage location in response to a determination that a corresponding sub-set of the user data has been stored in the data cache.

10. An Information Handling System (IHS), comprising:
a processor; and
a memory coupled to the processor, the memory including program instructions stored thereon that, upon execution by the processor, cause the IHS to:
store user data in a data storage location that is remote to the IHS;
determine a subset of the user data for local storage in response to a data storage policy and at least one usage attribute; and
store the sub-set of the user data in a data cache that is local to the IHS.

11. The IHS of claim 10, wherein the IHS is further configured to determine whether a requested sub-set of user data is stored in the data cache obtain the requested sub-set of user data from the data cache in response to a determination that the requested sub-set user data is stored in the data cache and obtaining the requested sub-set of user data from the data storage location in response to a determination that the requested sub-set of user data is not stored in the data cache.

12. The IHS of claim 10, wherein the usage attribute comprises a device-specific attribute.

13. The method of claim 10, wherein the usage attribute comprises a data-specific attribute.

14. The method of claim 10, wherein the usage attribute comprises a user-specific attribute.

15. The IHS of claim 10, further configured to store the requested sub-set of user data in the data cache in response to the requested sub-set of user data being obtained from the data storage location.

16. The IHS of claim 10, further configured to maintain a data cache of user data on each of a plurality of user interface devices, each user interface device being configured to access user data stored in the data storage location, each data cache comprising a device-specific sub-set of user data.

17. The IHS of claim 16, further configured to synchronize updates to user data cached in the data cache of a first user interface device with corresponding user data in the storage location and with corresponding user data stored in a data cache of a second user interface device.

18. The IHS of claim 10, further configured to flag a sub-set of the user data stored on the data storage location in response to a determination that a corresponding sub-set of the user data has been stored in the data cache.

19. A non-transitory computer-readable medium having program instructions stored thereon that, upon execution by an Information Handling System (IHS), cause the IHS to:
store user data in a data storage location that is remote to the IHS;
determine a subset of the user data for local storage in response to a data storage policy and at least one usage attribute; and store a sub-set of the user data in a data cache that is local to the IHS.

20. The non-transitory computer-readable medium of claim 19, further comprising instructions to determine whether a requested sub-set of user data is stored in the data cache, and obtain the requested sub-set of user data from the data cache in response to a determination that the requested sub-set user data is stored in the data cache and obtaining the requested sub-set of user data from the data storage location in response to a determination that the requested sub-set of user data is not stored in the data cache.
